(19) United States
(12) Patent Application Publication
(10) Pub. No.: US 2014/0132163 A1
(43) Pub. Date: May 15, 2014

(54) HIGH-VOLTAGE LED MULTICHIP MODULE AND METHOD FOR ADJUSTING AN LED MULTICHIP MODULE

(71) Applicants: Frank Baumann, Regensburg (DE); Ulrich Biebel, Rennertshofen (DE); Andreas Biebersdorf, Regensburg (DE); Hubert Maiwald, Neutraubling (DE); Hansjoerg Schoell, Bad Abbach (DE); Axel Kaltenbacher, Mintraching (DE)

(72) Inventors: Frank Baumann, Regensburg (DE); Ulrich Biebel, Rennertshofen (DE); Andreas Biebersdorf, Regensburg (DE); Hubert Maiwald, Neutraubling (DE); Hansjoerg Schoell, Bad Abbach (DE); Axel Kaltenbacher, Mintraching (DE)

(73) Assignee: OSRAM GmbH, Muenchen (DE)

(21) Appl. No.: 14/130,685

(22) PCT Filed: Jun. 26, 2012
(86) PCT No.: PCT/EP2012/062319

§ 371 Date: Jan. 3, 2014

(30) Foreign Application Priority Data
Jul. 4, 2011 (DE) 10 2011 078 620.1

(51) Int. Cl. H05B 33/08

(52) U.S. Cl. CPC H05B 33/0821
USPC 315/185 R

(57) ABSTRACT

An LED multichip module may include a plurality of LED chips, which have electrical terminals and are connected in series via electrical connections, and have a designated operating voltage, wherein at least one short-circuiting connection is provided, which connects two of the terminals or connections electrically conductively to one another, and the short-circuiting connection bypasses at least one of the LED chips or a resistor, with the result that the operating voltage is in the range of between 150 V and 350 V.

### RELATED APPLICATIONS

The present application is a national stage entry according to 35 U.S.C. §371 of PCT application No.: PCT/EP2012/062319 filed on Jun. 26, 2012, which claims priority from German application No.: 102011078620.1 filed on Jul. 4, 2011, and is incorporated

### TECHNICAL FIELD

Various embodiments relate to LED multichip modules which can be operated on high voltages.

### BACKGROUND

Light-emitting means in which light-emitting diodes (LEDs) are used can contain individual LED chips or else a plurality of LED chips connected to one another to form a module. US 2010/0006868 A1 describes an LED component which has series and parallel circuits of LEDs for operation on different predetermined AC voltages.

In order to match the mains voltage to the operating voltage of an LED multichip module, driver circuits are generally used which can have a particularly simple, compact, efficient and inexpensive design when the required operating voltage is relatively high. A high operating voltage of typically 280 V, for example, is made possible by a series circuit of LEDs. In this case, there is the problem of the actual operating voltage fluctuating as a result of the manufacturing tolerances of the LED. Therefore, the aim is to find possible ways of keeping the operating voltages of the LED multichip modules in a predetermined narrow tolerance range.

### SUMMARY

Various embodiments specify how a property of an LED multichip module, in particular the operating voltage thereof, can be adjusted to a preset value in a reliable and inexpensive manner.

The LED multichip module has a plurality of LED chips, which have electrical terminals and are connected in series via electrical connections. At least one short-circuiting connection is provided, which connects two of the terminals or connections electrically conductively to one another and bypasses at least one of the LED chips or a resistor, with the result that the operating voltage is in the range of between 150 V and 350 V.

In one embodiment of the LED multichip module, the operating voltage is in the range of between 270 V and 300 V.

In a further embodiment of the LED multichip module, the operating voltage is in the range of between 250 V and 290 V.

In a further embodiment of the LED multichip module, the short-circuiting connection is effected by a bonding wire.

In a further embodiment of the LED multichip module, the short-circuiting connection is effected by a conductor track of a structured metal plane.

In a further embodiment of the LED multichip module, an electrical resistor is connected into one of the connections and/or into the at least one short-circuiting connection, and the resistor is dimensioned such that it increases the operating voltage by a value in the range of between 0.1 V and 3 V, in particular in the range of between 1 V and 3 V.

In a method for adjusting an LED multichip module, LED chips which have electrical terminals are connected in series via electrical connections, and at least one short-circuiting connection is produced between the terminals or connections.

In another method for adjusting an LED multichip module, LED chips which have electrical terminals are connected in series via electrical connections. Various short-circuiting connections are produced between the terminals or connections. At least one of the short-circuiting connections is interrupted retrospectively.

In embodiments of the method, the operating voltage is adjusted within the range of between 150 V and 350 V, and in further embodiments said operating voltage is adjusted within the range of between 270 V and 300 V or within the range of between 250 V and 290 V.

In further embodiments of the method, at least one optical property of the LED multichip module is adjusted. The optical property can be, for example, the brightness of the radiation emitted during operation of the LED multichip module, the color of said radiation, the color rendering index (CRI) thereof or the emission characteristic thereof. In order to enable the adjustment, the LED multichip module can in particular be constructed of LED chips with different optical properties.

In further embodiments of the method, an electrical resistor is provided which is bypassed by the at least one short-circuiting connection or by a further short-circuiting connection. The resistor is connected between two of the terminals or connections by virtue of the short-circuiting connection bypassing the resistor being interrupted. The operating voltage is increased by the resistor by a value in the range of between 0.1 V and 3 V, in particular in the range of between 1 V and 3 V.

In further embodiments of the method, one of the LED chips is provided with further electrical connections, with the result that the terminals of further LED chips which are connected to one of the terminals of this LED chip are also connected to the respective other terminal of this LED chip. Two of the further electrical connections are interrupted, with the result that each terminal is now only connected to in each case one other terminal. With this configuration of the method, it is possible in particular to match parallel-connected series circuits of LEDs to one another: a last LED in the arrangement is connected to one of the series circuits depending on the selection of the interrupted further electrical connections, with the result that the relevant series circuit is thus extended.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic of an arrangement of LED chips which are connected via bonding wires and are provided with short-circuiting connections;

FIG. 2 shows the arrangement shown in FIG. 1 after the interruption of a short-circuiting connection;

FIG. 3 shows a schematic of an arrangement of LED chips which are connected via conductor tracks and are provided with short-circuiting connections;

FIG. 4 shows the arrangement shown in FIG. 3 after the interruption of a short-circuiting connection;

FIG. 5 shows a schematic of an arrangement of LED chips which are connected via conductor tracks and are provided with bypassed resistors;

FIG. 6 shows the arrangement shown in FIG. 5 after the interruption of bypasses;

FIG. 7 shows a schematic of an arrangement of LED chips which are connected via conductor tracks and are provided with further electrical connections for implementing different circuit arrangements;

FIG. 8 shows the arrangement shown in FIG. 7 for an example of a circuit arrangement;

FIG. 9 shows the arrangement shown in FIG. 7 for a further example of a circuit arrangement;

FIG. 10 shows a schematic of an LED multichip module in a plan view;

FIG. 11 shows an LED driver circuit including a current controller; and

FIG. 12 shows an LED driver circuit as shown in FIG. 11 with an input capacitor.

### DETAILED DESCRIPTION

The following detailed description refers to the accompanying drawing that show, by way of illustration, specific details and embodiments in which the disclosure may be practiced.

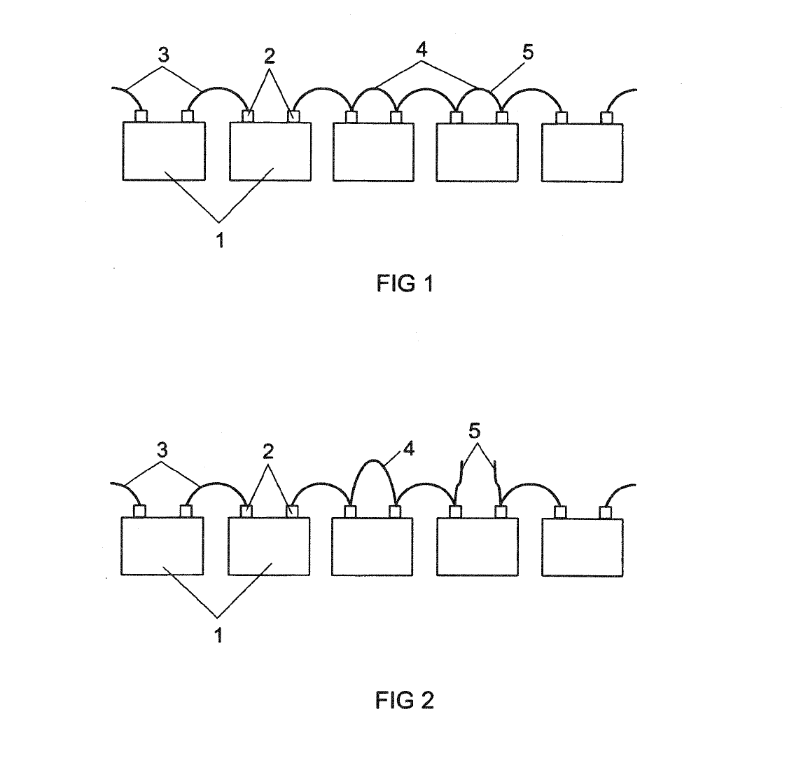

FIG. 1 shows a schematic of a series circuit of LED chips 1. The LED chips 1 can be produced, for example, on a substrate consisting of sapphire. Terminals 2, which are connected to one another via electrical connections 3, are provided for the electrical connection of the LEDs on upper sides of the LED chips 1. Series circuits of LEDs can be connected in parallel with one another and each include the same number or else different numbers of LEDs. Short-circuiting connections 4 produce electrical connections between some of the terminals 2, which are thus short-circuited, with the result that the relevant LED chips 1 are out of operation during operation of the series circuit. The short-circuiting connections 4 can in each case short-circuit two terminals 2 of the same LED chip 1, as in the example shown in FIG. 1, or instead also be provided between terminals 2 of different LED chips 1. In the embodiment shown in FIG. 1, the connections 3 and the short-circuiting connections 4 are each bonding wires 5.

FIG. 2 shows the arrangement shown in FIG. 1 after interruption of one of the bonding wires 5 which were provided as short-circuiting connections 4. The relevant LED chip 1 is thus activated, i.e. has been brought into the series circuit. By virtue of the interruption of suitably selected short-circuiting connections 4, the operating voltage of the series circuit of the LED chips 1 can be adjusted to a desired value. A bonding wire 5 can be interrupted, for example, by a mechanical tool or by the use of a laser.

In order to adjust the operating voltage of the LED multichip module, first LED chips 1 in the series circuit are bypassed, as shown in FIG. 1, by short-circuiting connections 4, with the result that it can be assumed that the actual operating voltage is below the designated operating voltage. During or after a measurement of the operating voltage, as many short-circuiting connections 4 are interrupted as is required for the predetermined operating voltage to be at least approximately reached or to be within accepted tolerance limits. Fine tuning can be performed, if required, by means of a laser-trimmable resistor, for example. By virtue of the interruption of selected short-circuiting connections 4, optical properties of the LED multichip module, such as brightness, color, emission characteristic or the like, for example, can be matched to the respective requirements instead of or in addition to the operating voltage.

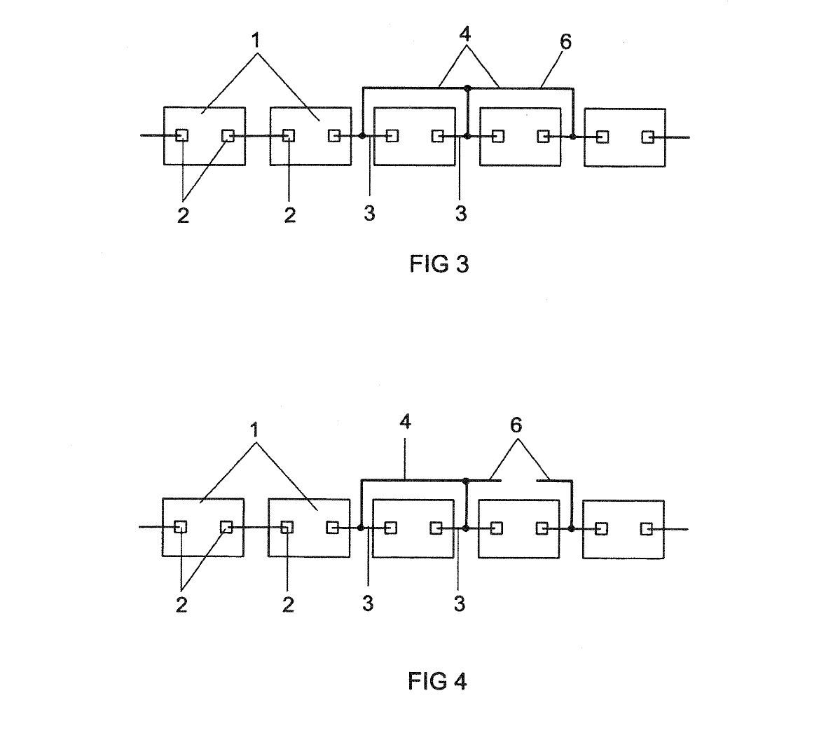

FIG. 3 shows a schematic of a series circuit of LED chips 1 in a plan view on the upper sides provided with the terminals 2. In the exemplary embodiment shown in FIG. 3, the connections 3 and short-circuiting connections 4 are each conductor tracks which can be formed, for example, in a structured metal plane. One or more of the conductor tracks 6 which are provided as short-circuiting connections 4 can be interrupted, for example severed by means of a laser beam in order to bring one or more LED chips 1 into the series circuit.

FIG. 4 shows the arrangement shown in FIG. 3 after interruption of one of the conductor tracks 6 which were provided as short-circuiting connections 4. The relevant LED chip 1 is connected in in this way and included in the series circuit. In the exemplary embodiment shown in FIGS. 3 and 4 as well, optical properties of the LED multichip module can be changed or matched by the interruption of selected short-circuiting connections 4.

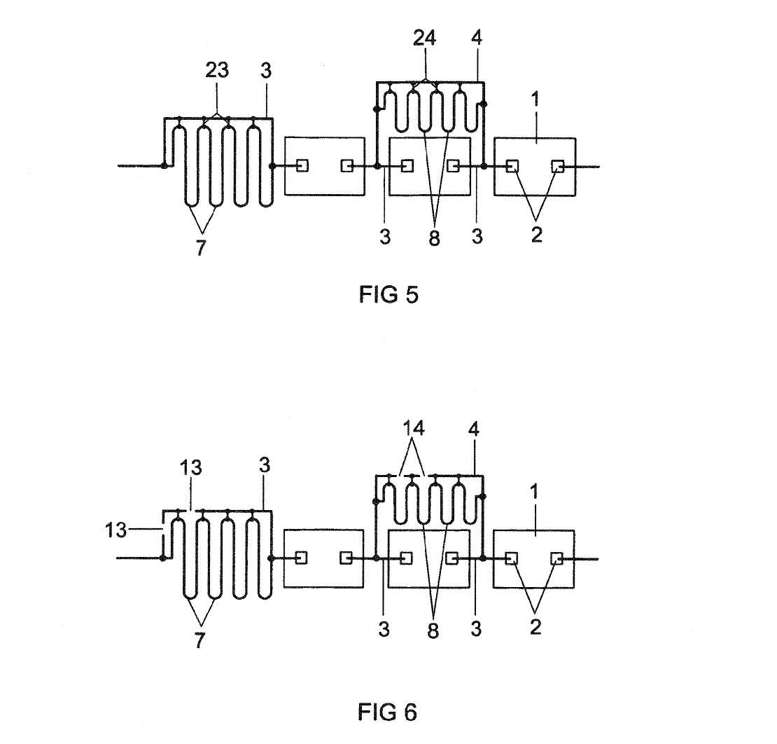

FIG. 5 shows a schematic of an arrangement shown in FIG. 3 with additional resistors 7 and 8. The resistor 7 illustrated on the left-hand side in FIG. 5 is connected in parallel with one of the electrical connections 3 between two LED chips 1 in succession in the series circuit. The resistor 8 illustrated further towards the right is connected in parallel with one of the short-circuiting connections 4. By virtue of a plurality of cross connections 23 between the connection 3 and the resistor or a plurality of cross connections 24 between the short-circuiting connection 4 and the resistor 8, the resistors 7, 8 are divided into sections.

FIG. 6 shows the arrangement shown in FIG. 5 after interruptions 13 of the connection 3 connected in parallel with the resistor and interruptions 14 of the short-circuiting connection 4 connected in parallel with the resistor 8 have been produced. Owing to the interruptions 13, sections of the resistor 7 are now within the series circuit of the LED chips 1, with the result that the total resistance of the series circuit is changed. Owing to the interruptions 14, sections of the resistor 8 are connected in parallel with the relevant LED chip 1, with the result that the total resistance of the series circuit is likewise changed thereby, but furthermore also the voltage drop occurring at this LED chip 1, which is now only short-circuited via one resistor 8, is changed in relation to the total voltage.

With such resistors 7, 8 which are initially bypassed by means of short-circuiting connections 4 and are subsequently connected in sectionally as required, fine tuning of the electrical properties and/or the optical properties of the LED module can be performed. Therefore, parallel-connected series of LEDs can also be matched to one another.

A laser-trimmable resistor can be integrated in a metal layer which is provided for forming the electrical connections 3 and the short-circuiting connections 4. Instead, the resistor can be integrated in a substrate of the LED multichip module, with the result that the trimming can take place outside the LED array. The resistor can in this case be, for example, a conductor track with a meandering structure or can be integrated in a core printed circuit board consisting of metal. For example, electrical conductors of different lengths can be led up to the LED array; all of the conductors are connected in parallel and, if required, the respective shortest conductors are interrupted.

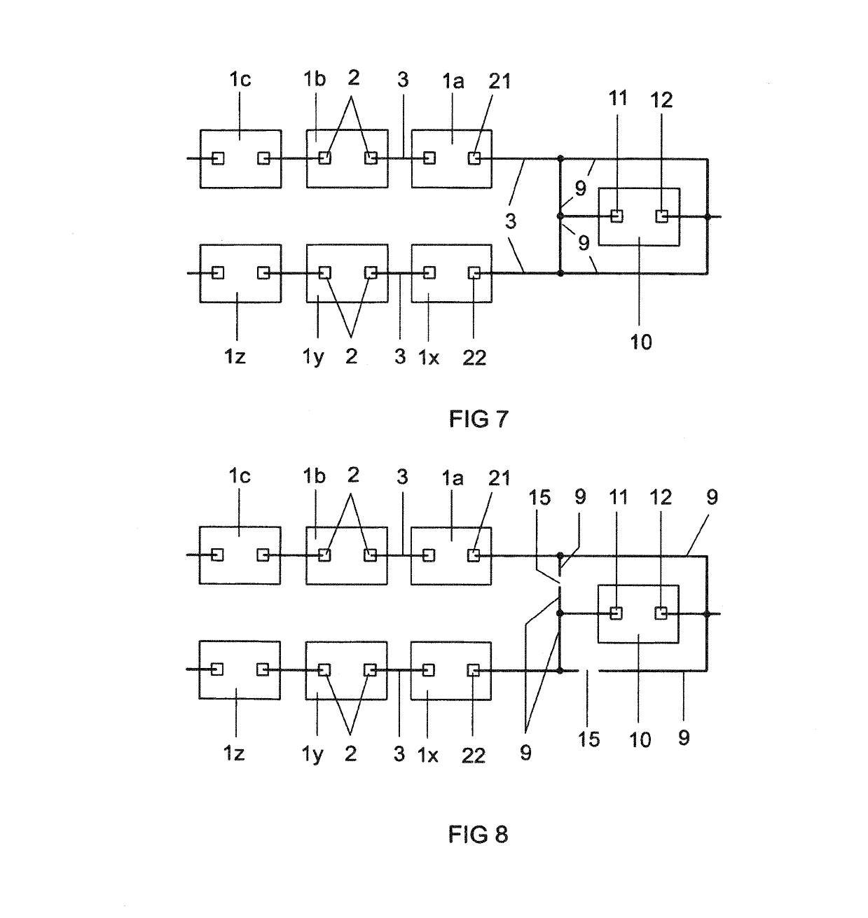

FIG. 7 shows a schematic of an arrangement shown in FIG. 3 with further electrical connections 9 to a specific LED chip 10 at an end position in the circuit. Without the further electrical connections 9, a terminal 11 of said LED chip 10 would be connected via one of the electrical connections 3 provided to a terminal 21 of the preceding LED chip la in the series circuit and a further terminal 12 of said LED chip 10 would be connected to a terminal 22 of the following LED chip lx in the series circuit. The further electrical connections 9 mean that both terminals 11, 12 of the LED chip 10 are connected to the terminal 21 of the preceding LED chip la and to the terminal 22 of the following LED chip lx.

FIG. 8 shows the arrangement shown in FIG. 7 once two of the further electrical connections 9 have been interrupted. The interruptions 15 mean that the terminal 11 of the LED chip 10 is connected to the terminal 22 of the following LED chip 1x, and the terminal 12 of the LED chip 10 is connected to the terminal 21 of the preceding LED chip 1a. If the terminal 12 is acting as a terminal of the operating voltage, the LED chip 10 is connected in series, via its terminal 11, with the series of LED chips 1x, 1y, 1z etc., which are illustrated in the lower series in FIGS. 7 and 8, and this series is connected in parallel with the upper series of the LED chips 1a, 1b, 1c etc.

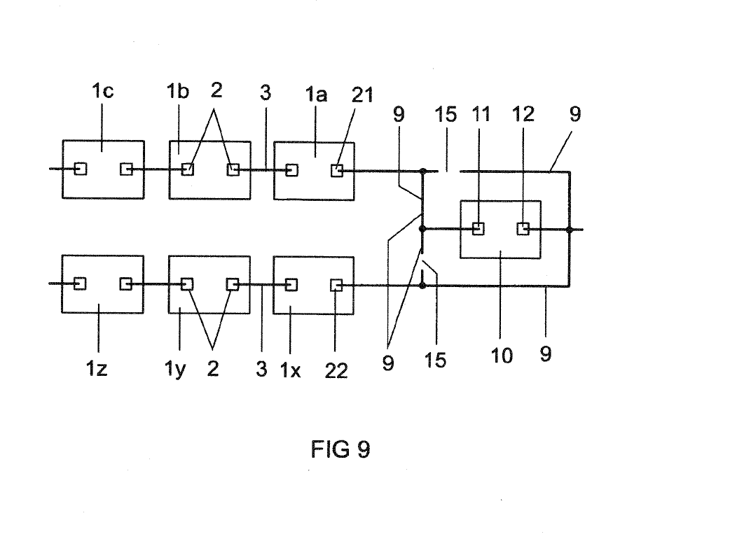

FIG. 9 shows the arrangement shown in FIG. 7 once two others of the further electrical connections 9 have been interrupted. In this case, the interruptions 15, in contrast to the arrangement shown in FIG. 8, mean that the terminal 11 of the LED chip 10 is connected to the terminal 21 of the preceding LED chip 1a, and the terminal 12 of the LED chip 10 is connected to the terminal 22 of the following LED chip 1x. If the terminal 12 is acting as a terminal of the operating voltage, the LED chip 10 is connected in series, via its terminal 11, with the upper series of LED chips 1a, 1b, 1c, etc., and the upper series is also in this case connected in parallel with the lower series of LED chips 1x, 1y, 1z etc.

An LED is connected to the remaining LEDs with the further electrical connections 9 in such a way that it can be connected to one series or the other series of LEDs, as required, by virtue of the corresponding short-circuiting links being interrupted. Series of LEDs connected in parallel with one another can thus be matched to one another. For this purpose, for example, an electrical or optical property can be measured and, on the basis of this measurement, that series which needs to be extended by connecting the last LED in order to match its measured value to the measured values of the other series can be determined.

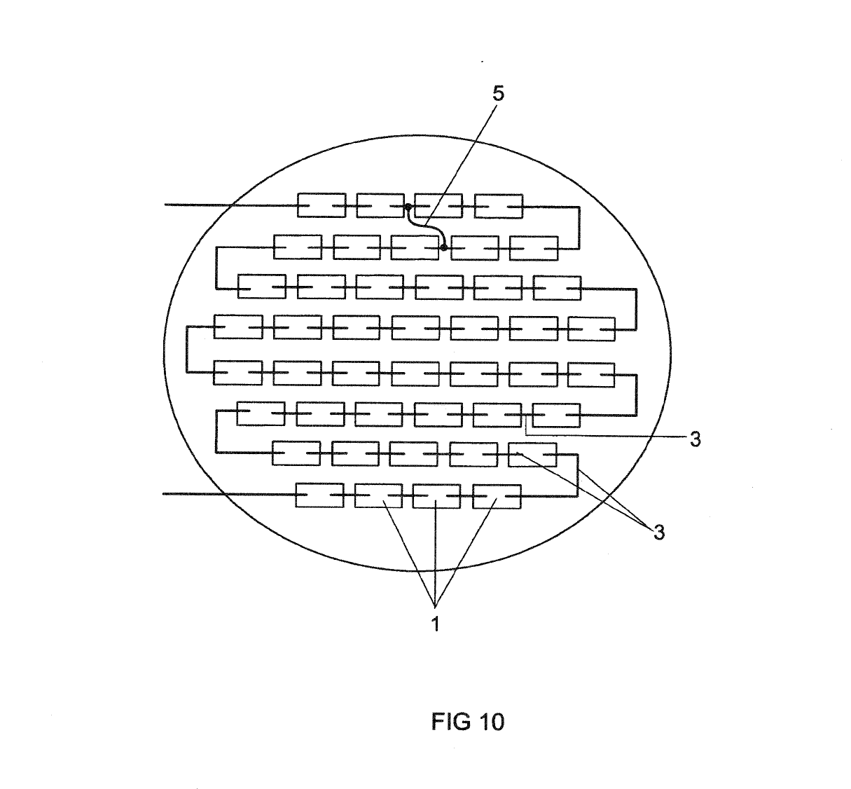

FIG. 10 shows a schematic of an LED multichip module in a plan view. The LED chips 1 are connected in series by means of electrical connections 3. A short-circuiting connection has been produced by a bonding wire 5, with which short-circuiting connection a number of LEDs (four LEDs in the example shown) have been short-circuited and an electrical and/or optical property of the LED multichip module has subsequently been adjusted in a desirable manner. It is possible for a plurality of such short-circuiting connections to be fitted. The LEDs do not all need to be connected in series; instead, a parallel circuit of series of LEDs can be provided in the LED multichip module.

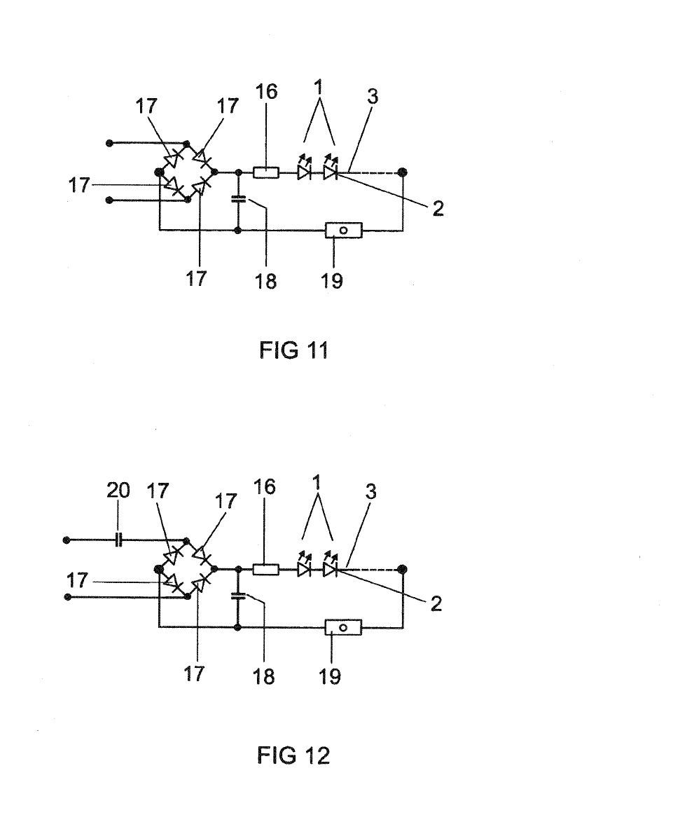

FIG. 11 shows a linear driver circuit suitable for the LED multichip module including a resistor 16, which is connected in series with the LED chips 1, including an input-side bridge circuit constructed from diodes 17, including a capacitor 18 and including a current controller 19, which in the simplest case can be a resistor.

FIG. 12 shows the driver circuit shown in FIG. 11 with an input capacitor 20 for increasing the efficiency. This driver circuit is suitable for an LED current of up to approximately 20 mA.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED multichip module
comprising a plurality of LED chips, which have electrical terminals and are connected in series via electrical connections, and
having a designated operating voltage,
wherein
at least one short-circuiting connection is provided, which connects two of the terminals or connections electrically conductively to one another, and
the short-circuiting connection bypasses at least one of the LED chips or a resistor, with the result that the operating voltage is in the range of between 150 V and 350 V.

2. The LED multichip module as claimed in claim 1, wherein
the operating voltage is in the range of between 270 V and 300 V.

3. The LED multichip module as claimed in claim 1, wherein
the operating voltage is in the range of between 250 V and 290 V.

4. The LED multichip module as claimed in claim 1, wherein
the short-circuiting connection is formed by an interruptible bonding wire.

5. The LED multichip module as claimed in claim 1, wherein
the short-circuiting connection is formed by an interruptible conductor track.

6. The LED multichip module as claimed in claim 1, wherein
an electrical resistor is connected into at least one of the connections and/or into the at least one short-circuiting connection, and the resistor is dimensioned such that it increases the operating voltage by a value in the range of between 0.1 V and 3 V.

7. A method for adjusting an LED multichip module, the method comprising:
connecting LED chips which have electrical terminals in series via electrical connections, and
producing at least one short-circuiting connection between the terminals or connections.

8. A method for adjusting an LED multichip module, the method comprising:
connecting LED chips which have electrical terminals in series via electrical connections,
producing short-circuiting connections between the terminals or connections, and
interrupting at least one of the short-circuiting connections.

9. The method as claimed in claim 7, wherein the operating voltage is adjusted within the range of between 150 V and 350 V.

10. The method as claimed in claim 7, wherein the operating voltage is adjusted within the range of between 270 V and 300 V.

11. The method as claimed in claim 7, wherein the operating voltage is adjusted within the range of between 250 V and 290 V.

12. The method as claimed in claim 7, wherein
at least one optical property of the LED multichip module is adjusted.

13. The method as claimed in claim 7, wherein
an electrical resistor is provided, which is bypassed by the at least one short-circuiting connection or by a further short-circuiting connection,
the resistor is connected between two of the terminals or connections by virtue of the short-circuiting connection which bypasses the resistor being interrupted, and
the operating voltage is increased by the resistor by a value in the range of between 0.1 V and 3 V.

14. The method as claimed in claim 7, wherein
one of the LED chips is provided with further electrical connections, with the result that those terminals which are connected to one of the terminals of the LED chip provided with the further electrical connections are connected also to the respective other terminal of this LED chip via one of the further electrical connections, and
two of the further electrical connections are interrupted, with the result that each of the terminals is only connected to in each case one other of the terminals.

15. The method as claimed in claim 8, wherein
the operating voltage is adjusted within the range of between 150 V and 350 V.

16. The method as claimed in claim 8, wherein
the operating voltage is adjusted within the range of between 270 V and 300 V.

17. The method as claimed in claim 8, wherein
the operating voltage is adjusted within the range of between 250 V and 290 V.

18. The method as claimed in claim 8, wherein
at least one optical property of the LED multichip module is adjusted.

19. The method as claimed in claim 8, wherein
an electrical resistor is provided, which is bypassed by the at least one short-circuiting connection or by a further short-circuiting connection,
the resistor is connected between two of the terminals or connections by virtue of the short-circuiting connection which bypasses the resistor being interrupted, and
the operating voltage is increased by the resistor by a value in the range of between 0.1 V and 3 V.

20. The method as claimed in claim 8, wherein
one of the LED chips is provided with further electrical connections, with the result that those terminals which are connected to one of the terminals of the LED chip provided with the further electrical connections are connected also to the respective other terminal of this LED chip via one of the further electrical connections, and
two of the further electrical connections are interrupted, with the result that each of the terminals is only connected to in each case one other of the terminals.
